(19) United States
(12) Patent Application Publication
(10) Pub. No.: US 2023/0153127 A1
(43) Pub. Date: May 18, 2023

(54) DISPLAYING USER INTERFACE USING USER INTERFACE DEFINITION FILE

(71) Applicant: HEWLETT-PACKARD DEVELOPMENT COMPANY, L.P., Spring, TX (US)

(72) Inventors: Hyeonin JEONG, Seongnam-si (KR); Sangmin LEE, Seongnam-si (KR); Jeonghun KIM, Seongnam-si (KR); Ari KIM, Seongnam-si (KR)

(21) Appl. No.: 17/913,227

(22) PCT Filed: Nov. 17, 2020
(86) PCT No.: PCT/US2020/060826

§ 371 Date: Sep. 21, 2022

(30) Foreign Application Priority Data
Jun. 18, 2020 (KR) 10-2020-0074217

(51) Int. Cl. G06F 9/451; G06F 3/0481; G06F 3/12

(52) U.S. Cl. CPC G06F 9/451; G06F 3/0481; G06F 3/1203; G06F 3/1253

(57) ABSTRACT

An example electronic device includes a communication unit, a user interface unit, a processor, and a memory to store instructions executable by the processor. The processor executes the instructions to store, in the memory, a plurality of programs capable of controlling operations performed in an image forming device, store, in the memory, a first user interface definition file corresponding to the plurality of programs in the memory, in a case where a first program among the plurality of programs is executed, call the first user interface definition file, and, based on first definition information for the first program included in the first user interface definition file, display a user interface of the first program through the user interface unit.

### BACKGROUND

In a case where an electronic device receives a print job request for an image forming apparatus, the electronic device may display a user interface for setting information used in a print job through a certain program. A layout of the user interface displayed through the certain program may be updated by an administrator.

### BRIEF DESCRIPTION OF THE DRAWINGS

Various examples will be described below with reference to the following figures.

FIG. 1 illustrates an operation of distributing, by an administration device, a user interface definition file to an electronic device, and displaying, by the electronic device, a user interface of a certain program, based on the user interface definition file, according to an example.

FIG. 2A is a flowchart illustrating a method of operating an electronic device for displaying a user interface for a program, based on a user interface definition file, according to an example.

FIG. 2B is a flowchart illustrating a method of operating an electronic device for obtaining and storing a user interface definition file, according to an example.

FIG. 3 is a diagram illustrating a process of calling a user interface definition file stored in a memory, by a plurality of programs capable of controlling operations performed in an image forming apparatus, and displaying a user interface of a program based on definition information included in the user interface definition file, according to an example.

FIG. 4A is a diagram illustrating a user interface definition file including layout information of a user interface, according to an example.

FIG. 4B is a diagram illustrating a user interface definition file including layout information of a user interface by program, according to an example.

FIG. 5A is a diagram illustrating a user interface before a user interface definition file is applied, according to an example.

FIG. 5B is a diagram illustrating a user interface after a user interface definition file is applied, according to an example.

FIG. 6 is a diagram illustrating a user interface after a user interface definition file is applied, wherein the user interface includes definition information of the user interface defined by program, according to an example.

FIG. 7 is a block diagram illustrating an electronic device, according to an example.

FIG. 8 is a flowchart illustrating a method of operating an administration device that generates a user interface definition file and distributes the user interface definition file, according to an example.

FIG. 9 is a diagram illustrating a screen for receiving layout information of a user interface, according to an example.

FIG. 10 is a block diagram illustrating an administration device, according to an example.

FIG. 11 is a diagram illustrating instructions stored in a computer-readable storage medium, according to an example.

FIG. 12 is a diagram illustrating instructions stored in a computer-readable storage medium, according to an example.

### DETAILED DESCRIPTION OF EXAMPLES

Hereinafter, examples of the disclosure will be described with reference to the accompanying drawings. However, the disclosure may be implemented in various different forms and is not limited to the examples described herein.

An “image forming device” may be any type of device capable of performing an image-forming operation, such as a printer, a copier, a scanner, a fax machine, a multi-function printer (MFP), or a display device. Further, the image-forming device may be a two-dimensional (2D) image-forming device or a three-dimensional (3D) image-forming device. An “operation performed on the image forming device” may be an operation related to printing, copying, scanning, faxing, storing, transmitting, coating, and the like.

An “administration device” may be a device that manages an image-forming device. For example, the administration device may transmit, to an image forming device, information for managing or controlling the image-forming device, and receive, from the image forming device, processing information or status information of the image-forming device. In an example, the administration device may transmit, to a plurality of image forming devices, information for managing or controlling each image-forming device, and receive, from each image forming device, processing information or status information of the respective image-forming device. In addition, the administration device may transmit administration information of the image-forming device to an electronic device of a user using the image-forming device. For example, the administration device may be a server, and the electronic device may be a host personal computer (PC).

Programs running on the electronic device may include a user interface used to control the image-forming device. For example, the programs may be a Windows Store app or a desktop app. The Windows Store app may be referred to as a Universal Windows Platform (UWP) app. The UWP app may refer to an app that may be used in a Windows 8 or higher operating system (OS). The desktop app may be an app developed using Windows Forms and Windows Presentation Foundation (WPF). Here, a user interface of the Windows Store app and a user interface of the desktop app are each managed separately.

In a case where there is a change in a component included in a user interface, an administrator distributes a configuration file of the program corresponding to the user interface to the user. The user installs an updated version of the program, thereby changing the components of the user interface. In this case, it is necessary to wait for the updated version of the program to be released, and to install the updated version for each program, which is inconvenient. For example, a component may be an object displayed on a user interface displayed on the electronic device or the administration device. For example, the component may indicate at least one piece of item information corresponding to a command for controlling an operation of the image-forming device. For example, in relation to a print job, the component may be an object representing item information such as a page size, an output size, a page layout, the number of copies, whether to print on both sides, etc. For example, the component may be provided as a fixed object on the user interface or may be provided as a movable object according to a user input. Further, the component may be provided in the form of receiving a user input on the user interface. For example, components may be displayed as input controls, such as checkboxes, radio buttons, drop-down lists, list boxes, buttons, toggle buttons, text entry fields, etc., moving components, such as breadcrumbs, slides, search fields, pagination, tags, icons, etc., information providing components, such as a tooltips, icons, progress bars, notifications, message boxes, modal windows, etc., and visual user interface elements such as containers.

Because the UWP app runs on the OS of Windows 8 or higher, it is not possible to use the configuration file of the user interface of the UWP app on the Windows 7 or earlier OS using WPF. Therefore, the administrator separately develops a configuration file for a user interface of an app running on Windows 7 or earlier OS, as well as a configuration file for a user interface of an app running on Windows 8 or higher OS, which is inconvenient.

In order to reduce the inconvenience of developing or installing a user interface configuration file for each program due to a change in the layout of the user interface, the administration device may generate a user interface definition file that may be commonly applied in a plurality of programs to distribute the generated user interface definition file to an electronic device of the user. Further, the electronic device of the user may store the distributed user interface definition file and apply the user interface definition file to each program, so that the layout of the user interface may be easily changed. That is, the electronic device may simultaneously change or synchronize the layout or component of a user interface of a plurality of programs by using one user interface definition file.

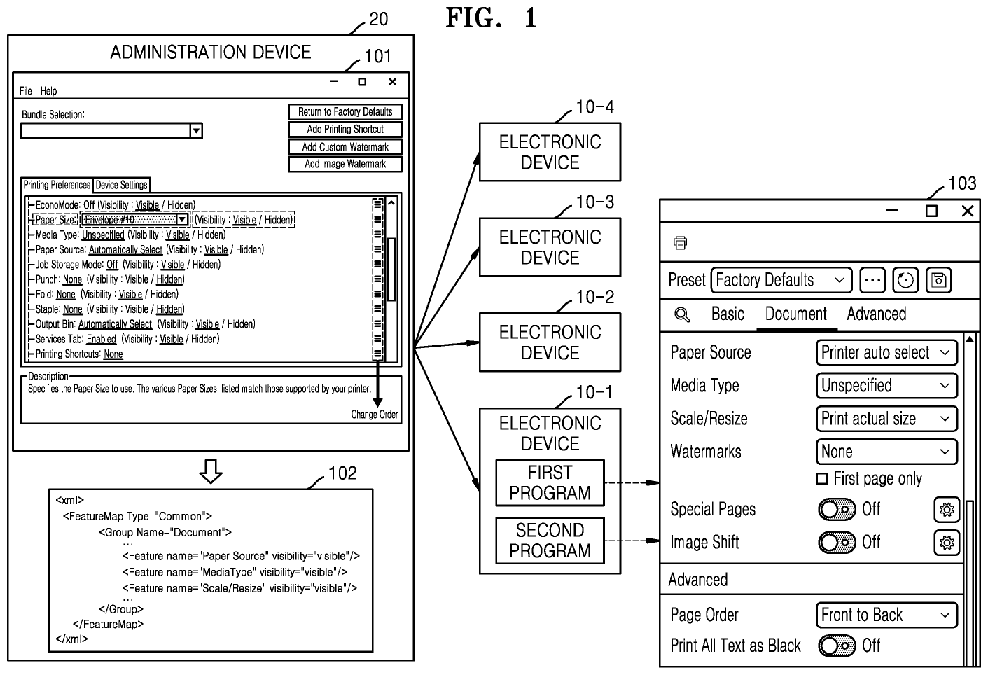

FIG. 1 illustrates an operation of distributing, by an administration device, a user interface definition file to an electronic device, and displaying, by the electronic device, a user interface of a certain program, based on the user interface definition file, according to an example.

Referring to FIG. 1, an administration device 20 may receive an input to set layout information of a user interface of a program used to control an operation of an image-forming device in electronic devices 10-1, 10-2, 10-3, and 10-4. For example, the administration device 20 may display a screen 101 in which component information may be set for components included in the user interface. The administration device 20 may receive component information through the screen 101.

In a case where an input for setting layout information of the user interface is received, the administration device 20 may generate a user interface definition file 102 that may be referenced by a plurality of programs, based on the input layout information of the user interface. For example, the user interface definition file 102 may be a file used to generate a user interface for a program that controls operations performed in the image-forming device. For example, the user interface definition file 102 may include layout information of a user interface provided by the program that controls an operation performed in the image-forming device. In addition, the user interface definition file 102 may include information of a component included in the user interface, a setting value of the component, a display position of the component, a display order of the component, whether the component is displayed, etc.

For example, the user interface definition file 102 may be an extensible markup language (XML) file. The administration device 20 may distribute the user interface definition file 102 to the electronic devices 10-1, 10-2, 10-3, and 10-4 using the image-forming device.

For example, the electronic device 10-1 may receive the user interface definition file 102 from the administration device 20. The electronic device 10-1 may store the user interface definition file 102 in a designated location in a registry of the electronic device 10-1. In a case where a first program or a second program that controls an operation of the image-forming device is executed in the electronic device 10-1, the electronic device 10-1 may call the user interface definition file 102, and may display a user interface 103 based on definition information of a program included in the user interface definition file 102. As an example, the electronic device 10-1 may change the layout of a user interface for each of the plurality of programs by using one user interface definition file 102 received from the administration device 20.

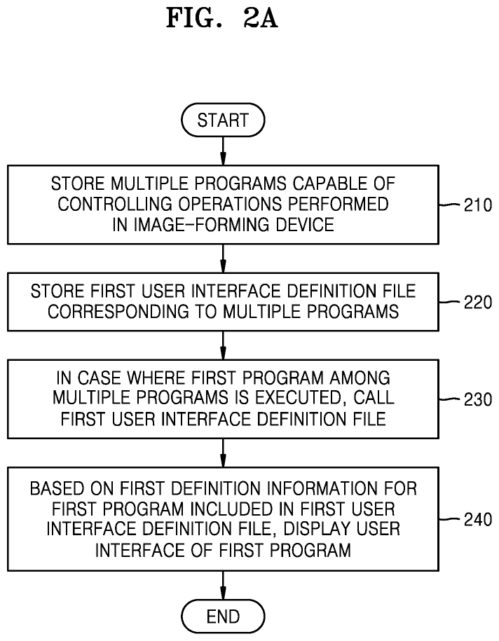

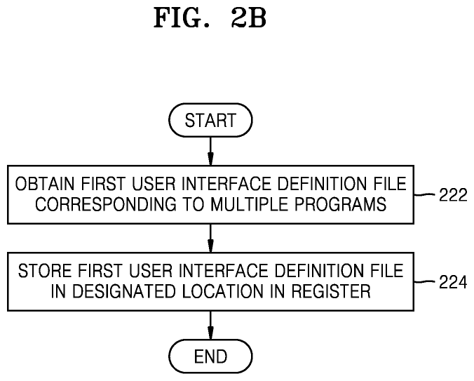

FIG. 2A is a flowchart illustrating a method of operating an electronic device for displaying a user interface for a program, based on a user interface definition file, according to an example.

Referring to FIG. 2A, the electronic device 10 may store a plurality of programs capable of controlling operations performed in the image forming device in operation 210. For example, the plurality of programs may include a desktop app developed from before Windows 7 and a Windows store app developed from Windows 8. In addition, Windows 10 may include a desktop app and a Windows store app. For example, a user interface related to operations performed in the image-forming device may be provided in each of the plurality of programs. For example, in order for the user to request a print job from each program to the image-forming device, a user interface related to the print job may be provided in each program.

In operation 220, the electronic device 10 may store a first user interface definition file corresponding to the plurality of programs. For example, the electronic device 10 may store the first user interface definition file referenced by each of the plurality of programs to generate a user interface.

For example, the user interface may be an interface provided so that preset information is exchanged between the image forming device and the user. The user may input a command for controlling the operation of the image forming device or input information related to an operation performed in the image-forming device, through the user interface. For example, in a case where a program is executed on the electronic device 10, the user interface may include a preset screen, an input window, a pop-up window, etc. provided within the program.

For example, the first user interface definition file may be a file used to generate user interfaces of the plurality of programs that control operations performed in the image-forming device. The plurality of programs may generate or change the user interface by commonly referring to the first user interface definition file stored in the electronic device 10.

For example, the first user interface definition file may include layout information of user interfaces provided by the plurality of programs. In this case, the first user interface definition file may include definition information of a user interface commonly applicable to the plurality of programs or definition information of user interfaces individually applicable to the plurality of programs. In addition, the plurality of programs may be classified into preset types, based on characteristic information of the programs. The first user interface definition file may include definition information of applicable user interfaces for each of the types into which the plurality of programs are classified.

For example, the first user interface definition file may include information of a component included in a first user interface, a setting value of the component, a display position of the component, a display order of the component, whether the component is displayed, etc. For example, a component included in the first user interface may refer to an item specified as one independent piece of information within the information displayed on the first user interface. For example, an item for a function supported by the image-forming device may be displayed as a component. For example, referring to the user interface 103 of FIG. 1, the component may be “Paper Source”, “Media Type”, “Scale/Resize”, “Watermarks”, “Special Pages”, “Image Shift”, “Page Order”, and the like. In addition, the first user interface definition file may include policy information related to the layout of user interfaces provided by the plurality of programs. For example, the first user interface definition file may be an XML file.

For example, the first user interface definition file may be applied to programs based on different platforms or frameworks of different user interfaces. For example, the first user interface definition file may be commonly applied to programs based on different platforms. For example, the first user interface definition file may be commonly applied to programs based on frameworks of different user interfaces, even in a case where the same platform is used.

For example, the platform may refer to a system that serves as a basis for executing a certain program. For example, the platform may include an OS, an auxiliary program of the system, a microprocessor, a microchip, and the like. For example, the OS may be designed to work with a particular microprocessor's instruction set. For example, the platform may be Windows, Macintosh, or the like. In addition, even in a case where the types of platforms are the same, different versions may mean different platforms.

For example, the framework may refer to a software platform that supports reuse of a preset portion in a software structure and to selectively implement a preset function related to application. For example, a framework of a user interface may be a software platform used to generate and display the user interface.

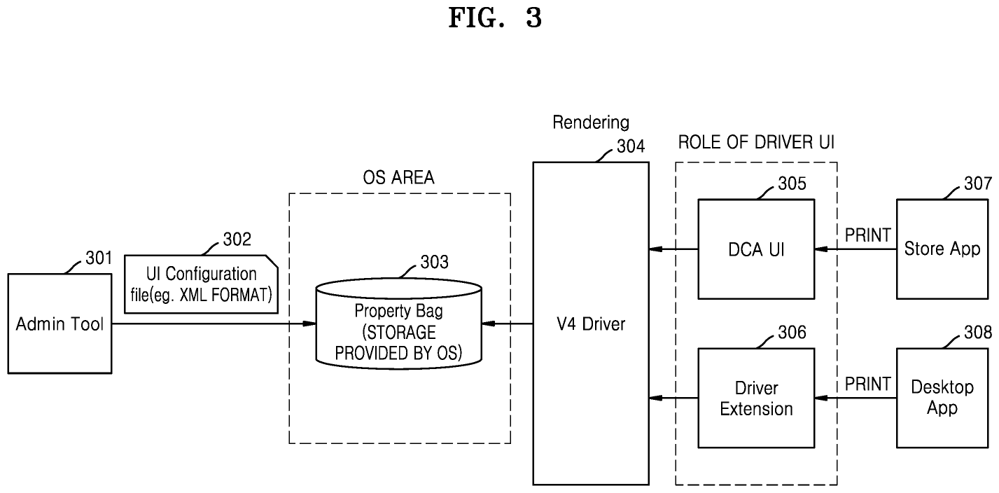

For example, the electronic device 10 may store the first user interface definition file in a designated location in a register in memory. For example, the electronic device 10 may store definition information in the first user interface definition file in a preset storage space of the electronic device 10. For example, the preset storage space may be a property bag in a Microsoft Windows OS. An example process of storing the first user interface definition file will be described with reference to FIG. 3.

In an example, the electronic device 10 may receive the first user interface definition file from the administration device 20 managing the image-forming device. In addition, the electronic device 10 may generate the first user interface definition file, based on an input for modifying layout information of a first user interface.

In operation 230, in a case where a first program among the plurality of programs is executed in the electronic device 10, the electronic device 10 may call the first user interface definition file. For example, in a case where the first program is executed on the electronic device 10, the electronic device 10 may call the first user interface definition file stored in the electronic device 10 to display a user interface of the first program.

In operation 240, the electronic device 10 may display the user interface of the first program, based on first definition information for the first program included in the first user interface definition file. For example, the electronic device 10 may obtain first definition information for the first program, wherein the first definition information is used to generate the user interface of the first program in the first user interface definition file. For example, the electronic device 10 may obtain the first definition information for the first program by identifying target information in the first user interface definition file. For example, the target information may include at least one of information commonly applicable to a plurality of programs, information individually applicable to a plurality of programs, and information applicable to types into which a plurality of programs are classified. The electronic device 10 may generate a user interface of the first program, based on the first definition information for the first program. The electronic device 10 may display the user interface of the first program.

For example, in a case where a second program among the plurality of programs is executed on the electronic device 10, the electronic device 10 may call the first user interface definition file. The electronic device 10 may display a user interface of the second program, based on the first definition information for the first program included in the first user interface definition file. In this case, a layout of the user interface of the second program may be the same as that of the user interface of the first program. That is, layout information about a component constituting the user interface of the second program, a setting value of the component, a display order of the component, a display location of the component, whether the component is displayed, etc., may be the same as layout information about a component constituting the user interface of the first program, a setting value of the component, a display order of the component, a display position of the component, whether the component is displayed, etc., respectively. In this case, the definition information included in the first user interface definition file may be set to be commonly applicable to the plurality of programs. In addition, the definition information included in the first user interface definition file may be set to be commonly applicable to the first program and the second program. For example, in the first program and the second program, information on types into which the plurality of programs are classified based on preset criteria may be the same.

For example, in a case where the second program among the plurality of programs is executed on the electronic device 10, the electronic device 10 may call the first user interface definition file. The electronic device 10 may display the user interface of the second program, based on second definition information for the second program included in the first user interface definition file. In this case, a layout of the user interface of the second program may be different from that of the user interface of the first program. For example, layout information about a component constituting the user interface of the second program, a setting value of the component, a display order of the component, a display location of the component, whether the component is displayed, etc., may be different from layout information about a component constituting the user interface of the first program, a setting value of the component, a display order of the component, a display position of the component, whether the component is displayed, etc. In this case, the definition information included in the first user interface definition file may be set to be individually applicable to the plurality of programs. In addition, the definition information included in the first user interface definition file may be set to be commonly applicable to the first program and the second program. For example, in the first program and the second program, information on types into which the plurality of programs are classified based on preset criteria may be different.

For example, in a case where a certain program among the plurality of programs is executed in the electronic device 10, the electronic device 10 may call the first user interface definition file that is pre-stored and obtain definition information for the certain program in the first user interface definition file. The electronic device 10 may generate a user interface of the certain program and display the generated user interface based on definition information about the certain program.

For example, after the user interface of the first program is provided, in a case where the first program is executed, the electronic device 10 may identify whether there is a second user interface definition file that is updated. For example, upon confirmation of the presence of an updated second user interface definition file, the electronic device 10 may update the user interface of the first program based on a second user interface definition file. Upon confirmation of the absence of an updated second user interface definition file, the electronic device 10 may display the user interface of the first program based on the first user interface definition file that is pre-stored.

For example, the electronic device 10 may obtain first target information for the first program in the first user interface definition file. The electronic device 10 may obtain, based on the first target information, the first definition information applied to the first program in the first user interface definition file. The electronic device 10 may generate the user interface of the first program based on the first definition information, and display the generated user interface of the first program.

FIG. 2B is a flowchart illustrating a method of operating an electronic device for obtaining and storing a user interface definition file, according to an example.

Referring to FIG. 2B, the electronic device 10 may obtain a first user interface definition file corresponding to a plurality of programs in operation 222. For example, the electronic device 10 may receive the first user interface definition file from the administration device 20 managing the image-forming device. For example, the electronic device 10 may generate the first user interface definition file, based on an input for modifying layout information of a first user interface.

In operation 224, the electronic device 10 may store the first user interface definition file in a designated location in a register of the memory of the electronic device 10.

FIG. 3 is a diagram illustrating a process of calling a user interface definition file stored in a memory, by a plurality of programs capable of controlling operations performed in an image forming apparatus, and displaying a user interface of a program based on definition information included in the user interface definition file, according to an example.

Referring to FIG. 3, the administration device 20 may execute an administration program that is used to generate a user interface definition file corresponding to a plurality of programs, according to an administrator input. For example, the administration program may be an Admin Tool 301. As the administration program is executed, the administration device 20 may display a screen for setting layout information of a user interface. The administration device 20 may receive an input for setting layout information of the user interface through a screen and generate a user interface definition file based on the input. For example, the user interface definition file may be a user interface (UI) configuration file 302. In addition, the user interface definition file may be in an XML format. The administration device 20 may distribute the UI configuration file 302 to the electronic device 10 in which a program for controlling operations of the image-forming device is stored. In addition, the electronic device 10 may execute an administration program stored in the electronic device 10, according to a user's input. The electronic device 10 may also generate a user interface definition file, based on a user input that has been input through a screen according to execution of the administration program.

For example, the electronic device 10 may store the user interface definition file in a preset storage space provided by an OS. For example, the preset storage space may be a property bag 303. In the property bag, definition information in the user interface definition file may be stored. For example, the administration device 20 may request, through the administration program, that the electronic device 10 calls an application programming interface (API) of the property bag 303 so that the user interface definition file is stored. The electronic device 10 may store definition information in the user interface definition file in a registry mapped to the property bag 303 internally in the OS. In addition, depending on the OS of the electronic device 10, a location of the registry may be changed.

For example, the OS of the electronic device 10 may be Windows 10. In a case where a print job is requested from a store app 307, the electronic device 10 may display a Device Companion App (DCA) UI 305. In addition, in a case where a print job is requested from a desktop app 308, the electronic device 10 may display a Driver Extension UI 306. For example, the DCA UI 305 and the Driver Extension UI 306 may call the user interface definition file by using a rendering module of a driver of the image-forming device, and display a user interface based on definition information included in the user interface definition file. For example, the driver of the image forming device may be a V4 driver 304. For example, the DCA UI 305 and the Driver Extension UI 306 may call the user interface definition file through the property bag 303 by reading a registry value.

For example, in a case where definition information to be applied to the store app 307 is identical to definition information to be applied to the desktop app 308, a layout of the DCA UI 305 may be identical to that of the Driver Extension U 1306.

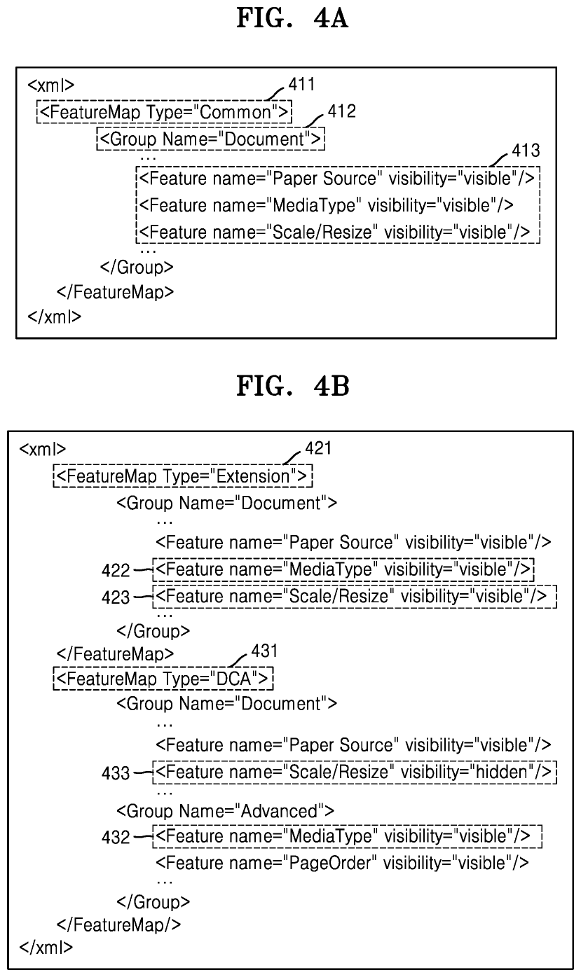

FIG. 4A is a diagram illustrating a user interface definition file including layout information of a user interface, according to an example.

Referring to FIG. 4A, the user interface definition file may be applied to programs based on different platforms or frameworks of different interfaces. In addition, the user interface definition file may include layout information of a user interface. For example, a format of the user interface definition file may be a format in a markup language such as XML.

For example, the user interface definition file may be designed to transmit structured data, information, and documents on the web. In addition, information included in the user interface definition file may be independently stored, searched, modified, and the like. Further, layout information of a user interface may include at least one piece of information among components included in the user interface, setting values of the components, a display order of the components, display positions of the components, whether the components are displayed. etc.

As illustrated in FIG. 4A, for example, the first user interface definition file may be an XML file. Further, the first user interface definition file may include definition information about a program to which the first user interface definition file is applied. For example, the first user interface definition file may include information 411 about a program to which the first user interface definition file is to be applied, group information 412 of components displayed in the first user interface, and information 413 about the components displayed in the first user and whether the components are displayed. For example, the components may be paper source, media type, scale/resize, and the like. In addition, whether the components are displayed may be set to visible.

Referring to FIG. 4A, the information 411 about a program to which the first user interface definition file is to be applied may be set to “Common”. In this case, the target subject to application may be a plurality of programs capable of controlling operations performed in the image-forming device. For example, programs based on different platforms or frameworks of different user interfaces may each display a user interface based on the first user interface definition file. In an example, an administrator or a user may differently set definition information to be applied according to types of programs capable of controlling operations performed on the image-forming device.

FIG. 4B is a diagram illustrating a user interface definition file including layout information of a user interface by program, according to an example.

Referring to FIG. 4B, in the first user interface definition file, layout information of a user interface may be stored for each target program. For example, the first user interface definition file may include layout information of the first user interface for an “Extension” type program and layout information of a second user interface for a “DCA” type program.

For example, the electronic device 10 or the administration device 20 may differently set the layout of a user interface of a plurality of programs capable of controlling operations performed in the image-forming device, based on characteristic information of the plurality of programs. For example, a first function provided in the image-forming device may be used in the first program, but may be restricted in the second program. In this case, the user or the administrator may set a component corresponding to the first function not to be displayed in the user interface of the second program. In addition, in the first program and the second program, a location in which a component corresponding to a second function provided in the image-forming device may be different. In this case, the user or the administrator may set locations in which a component corresponding to the second function differently in the first program and the second program.

For example, referring to FIG. 4B, layout information 421 of the first user interface may include information on a target to which the layout information of the first user interface is to be applied. The target may be an “Extension” type program. Further, the layout information 421 of the first user interface may include group information of a plurality of components displayed on the first user interface, and information on the plurality of components displayed on the first user interface and whether the components are displayed.

In addition, layout information 431 of the second user interface may include information on a target to which the layout information of the second user interface is to be applied. The target may be a “DCA” type program. Further, the layout information 431 of the second user interface may include group information of a plurality of components displayed on the second user interface, and information on the plurality of components displayed on the second user interface and whether the components are displayed.

On the other hand, in the layout of the first user interface, information 422 on whether the component for media type is displayed may be set to “visible” and may be set to be displayed in the “Document” group. On the other hand, in the layout of the second user interface, information 432 on whether the component for media type is displayed may be set to “visible” and may be set to be displayed in the “Advanced” group.

In addition, in the layout of the first user interface, information 423 on whether to display scale/resize may be set to “visible” and may be set to be displayed in the “Document” group. On the other hand, in the layout of the second user interface, information 433 on whether to display scale/resize may be set to “hidden” and may be set to be displayed in the “Document” group.

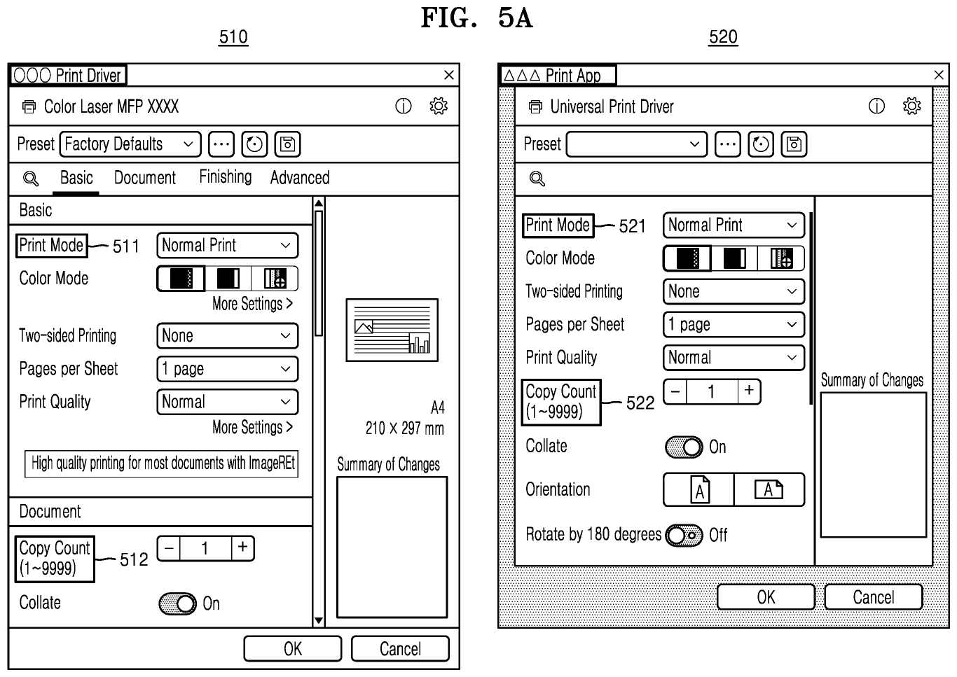

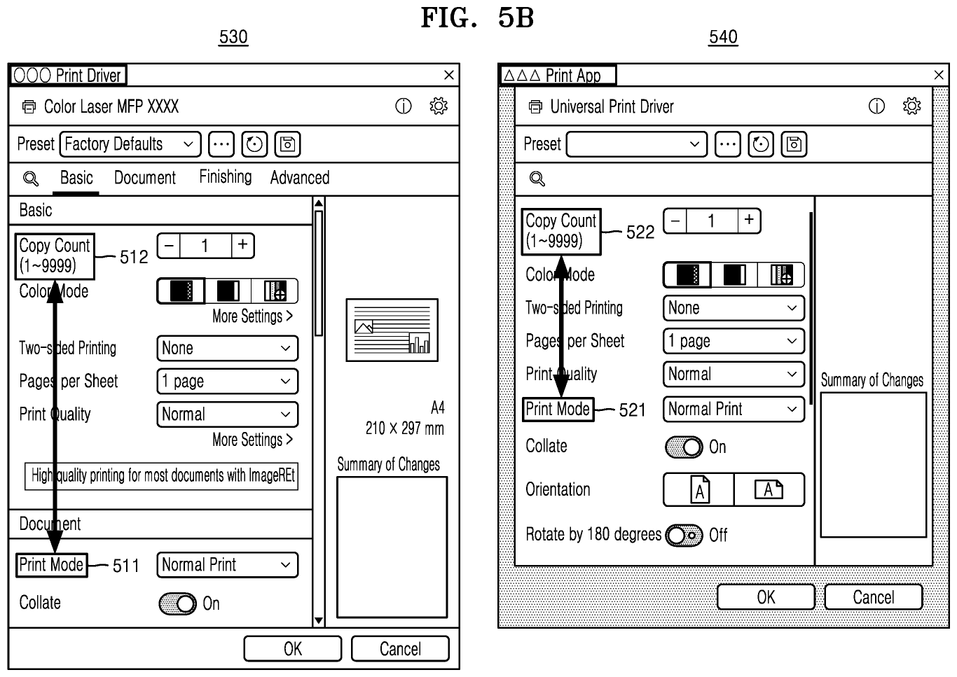

FIG. 5A is a diagram illustrating a user interface before a user interface definition file is applied, according to an example.

Referring to FIG. 5A, an image 510 shows the first user interface of the first program, and an image 520 shows the second user interface of the second program. For example, the first program and the second program may be installed on the electronic device 10. Depending on the program executed on the electronic device 10, the electronic device 10 may display the first user interface or the second user interface. As illustrated in FIG. 5A, the first user interface and the second user interface may display the same components.

In an example, while there are N print job requests, the number of times of setting for the “Copy Count” component may be greater than or equal to a first reference number, and the number of times of setting for the “Print Mode” component may be less than a second reference number. The user or the administrator may modify the display order of the components in the user interface in consideration of the frequency of use among the components in the user interface. For example, in a case where the order in which the component information for “Print Mode” (511, 521) is displayed is first, and the order in which component information for “Copy Count” (512, 522) is displayed is sixth, the user or the administrator may set the display order of the component information for “Print Mode” (511, 521) to sixth, and the display order in which the component information for “Copy Count” (512, 522) to first.

The electronic device 10 or the administration device 20 may receive an input for changing the display order of the component for “Print Mode” and the component for “Copy Count”, and based on the input, generate a user interface definition file in which the layout information of the user interface is stored. On the other hand, in a case where the user interface definition file is generated in the administration device 20, the administration device 20 may distribute the user interface definition file to the electronic device 10. The electronic device 10 may store the distributed user interface definition file in a designated location in the registry. In a case where the first program or the second program is executed in the electronic device 10, the electronic device 10 may call the user interface definition file from the registry, and update and display the layout of the user interface based on definition information included in the user interface definition file.

FIG. 5B is a diagram illustrating a user interface after a user interface definition file is applied, according to an example.

Referring to FIG. 5B. an image 530 shows the first user interface of the first program to which the user interface definition file is applied, and an image 540 shows the second user interface of the second program to which the user interface definition file is applied. That is, in order to update the layout of the user interface for each of the first program and the second program, the electronic device 10 may, without reinstalling an updated version of the first program and second program, call the user interface definition file stored in the registry when the first program or second program is executed, and generate and display a user interface based on definition information of each of programs included in the user interface definition information, thereby synchronizing the first user interface and the second user interface. That is, the electronic device 10 may simultaneously synchronize user interfaces of the plurality of programs by using one user interface definition file. In a case where the user interface definition file is updated, the electronic device 10 may easily synchronize a user interface of each program by applying the updated user interface definition file to each program.

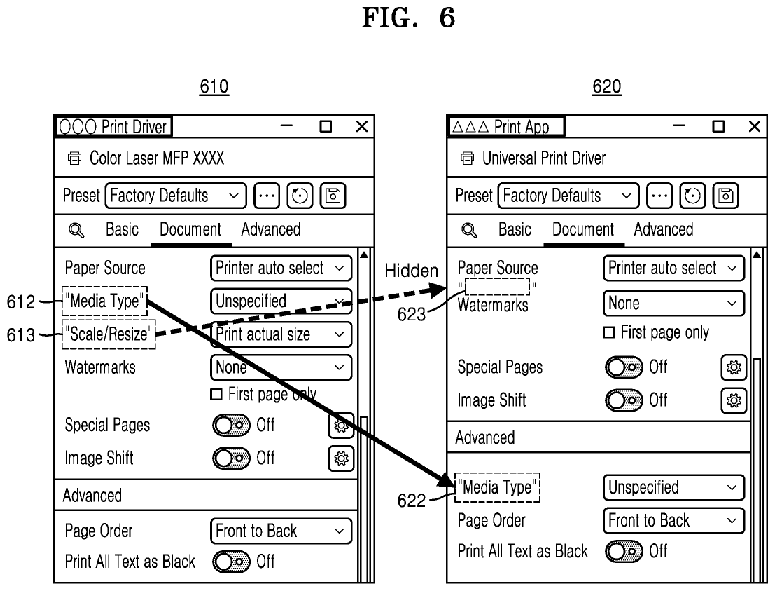

FIG. 6 is a diagram illustrating a user interface after a user interface definition file is applied, wherein the user interface includes definition information of the user interface defined by program, according to an example.

For example, first user interface definition information may include target information to which the first user interface definition information is applied. For example, as illustrated in FIG. 4B, layout information of a user interface may be stored in the first user interface definition file for each program corresponding to target information, based on the target information.

Referring to FIG. 6, an image 610 shows a layout of the first user interface described with reference to FIG. 4B. In addition, an image 620 shows a layout of the second user interface described with reference to FIG. 4B.

Comparing the layout of the first user interface with that of the second user interface, the component information 612 for the media type in the first user interface is displayed in the “Document” group, and the component information 622 for the media type in the second user interface is displayed in the “Advanced” group. In addition, component information 613 for scale/resize in the first user interface is displayed in the “Document” group, and component information 623 for scale/resize in the second user interface is not displayed.

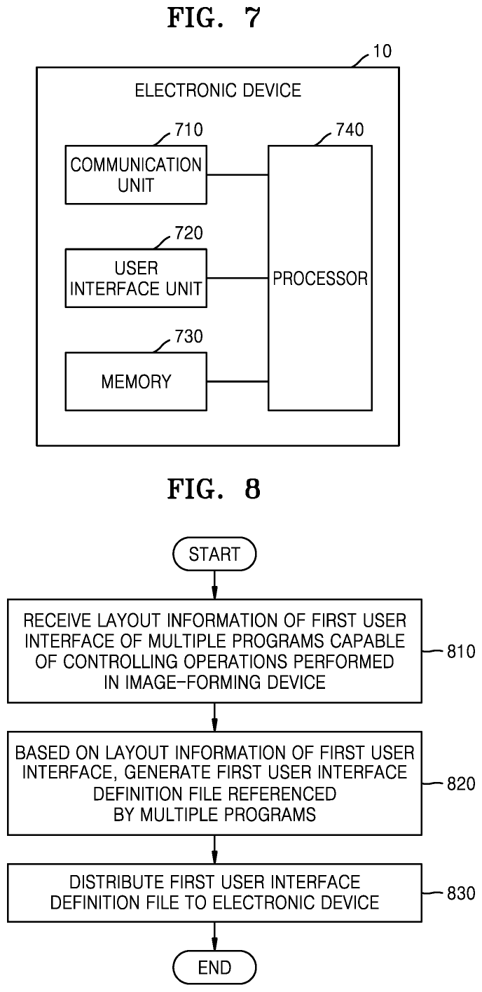

FIG. 7 is a block diagram illustrating an electronic device, according to an example.

Referring to FIG. 7, an electronic device 10 may include a communication unit 710, a user interface unit 720, a memory 730, and a processor 740. The electronic device 10 may be implemented by more components than the illustrated components, and the electronic device 10 may be implemented by fewer components. Examples of the components will be described below.

The communication unit 710 (e.g., transceiver) may communicate with an external device. For example, the communication unit 710 may be connected to a network by wired or wireless communication to communicate with an external device. Here, the external device may be an image-forming device, the administration device 20 for managing the image forming device, or a server.

The user interface unit 720 may include an input unit for receiving an input for controlling the operation of the electronic device 10 from the user, and an output unit for displaying information such as a result of operation of the electronic device 10, the status of the electronic device 10, or the like. For example, the user interface unit 720 may include an operation panel for receiving a user input, a display panel for displaying a screen, and the like.

The input unit may include a device capable of receiving various types of user input, such as a keyboard, a physical button, a touch screen, a camera, a microphone, or the like. In addition, the output unit may include, for example, a display panel, a speaker, or the like.

The memory 730 may store software, programs, etc. The memory 730 may store at least one program related to an operation of the electronic device 10 of obtaining a user interface definition file of a plurality of programs, and displaying a user interface of a certain program based on definition information of the certain program included in the user interface definition file.

The processor 740 may execute a program stored in the memory 730, read data or files stored in the memory 730, or store a new file in the memory 730. The processor 740 may execute instructions stored in the memory 730.

The processor 740 may store, in the memory 730, a plurality of programs capable of controlling operations performed in the image-forming device. For example, in each of the plurality of programs, a user interface related to operations performed in the image-forming device may be provided. For example, in order for the user to request a print job from each program to the image-forming device, a user interface related to the print job may be provided in each program.

The processor 740 may store the first user interface definition file corresponding to the plurality of programs, in the memory 730. For example, the memory 730 may store the first user interface definition file that is referenced by each of the plurality of programs to generate a user interface.

For example, the user interface may be an interface provided so that preset information is exchanged between the image forming device and the user. The user may input a command for controlling the operations of the image forming device or input information related to operations performed in the image-forming device through the user interface.

For example, the first user interface definition file may be a file used to generate user interfaces of the plurality of programs that control operations performed in the image-forming device. The plurality of programs may generate or change the user interface by commonly referring to the first user interface definition file stored in the electronic device 10.

For example, the first user interface definition file may include layout information of user interfaces provided by the plurality of programs. In this case, the first user interface definition file may include definition information of a user interface commonly applicable to the plurality of programs or definition information of user interfaces individually applicable to the plurality of programs. In addition, the plurality of programs may be classified into preset types based on characteristic information of the programs. The first user interface definition file may include definition information of applicable user interfaces for each of the types into which the plurality of programs are classified.

For example, the first user interface definition file may include at least one piece of information among components included in a first user interface, setting values of the components, display positions of the components, a display order of the components, whether the components are displayed, etc. For example, a component included in the first user interface may refer to an item specified as one independent piece of information within the information displayed on the first user interface. In addition, the component may refer to an item for functions supported by the image-forming device.

In addition, the first user interface definition file may include policy information related to the layout of user interfaces provided by the plurality of programs. In addition, the first user interface definition file may be a file having an XML format.

For example, the first user interface definition file may be applied to programs based on different platforms or frameworks of different user interfaces. For example, the first user interface definition file may be commonly applied to programs based on different platforms. For example, the first user interface definition file may be commonly applied to programs based on frameworks of different user interfaces, even in a case where the same platform is used.

For example, the platform may refer to a system that serves as a basis for executing a certain program. For example, the platform may include an OS, an auxiliary program of the system, a processor 740 (e.g., a microprocessor), a microchip, and the like. For example, the platform may be Windows, Macintosh, or the like. In addition, even in a case where the types of platforms are the same, different versions may refer to different platforms.

For example, the framework may refer to a software platform that supports reuse of a preset portion in a software structure, and selectively implements a preset function related to application. For example, a framework of a user interface may be a software platform used to generate and display the user interface.

For example, the processor 740 may store the first user interface definition file in a designated location in a register of the memory 730. For example, the processor 740 may store definition information in the first user interface definition file in a preset storage space of the electronic device 10. For example, the preset storage space may be a property bag of the OS.

In an example, the processor 740 may receive the first user interface definition file from the administration device 20 managing the image forming device through the communication unit 710. In addition, the processor 740 may generate the first user interface definition file, based on an input for modifying layout information of a first user interface.

In a case where the first program among the plurality of programs is executed in the electronic device 10, the processor 740 may call the first user interface definition file. For example, in a case where the first program is executed in the electronic device 10, the processor 740 may call the first user interface definition file stored in the property bag to display the user interface of the first program.

The processor 740 may display the user interface of the first program through the user interface unit 720, based on the first definition information for the first program included in the first user interface definition file.

For example, the processor 740 may obtain first definition information for the first program, wherein the first definition information is used to generate the user interface of the first program in the first user interface definition file. For example, the processor 740 may obtain the first definition information for the first program by identifying target information in the first user interface definition file. For example, the target information may include at least one of information commonly applicable to a plurality of programs, information individually applicable to a plurality of programs, information applicable to types into which a plurality of programs are classified, etc.

For example, the processor 740 may generate a user interface of the first program, based on first definition information for the first program. The processor 740 may display the user interface of the first program through the user interface unit 720.

For example, in a case where the second program among the plurality of programs is executed on the electronic device 10, the processor 740 may call the first user interface definition file. The processor 740 may display the user interface of the second program through the user interface unit 720, based on the first definition information for the first program included in the first user interface definition file.

In this case, a layout of the user interface of the second program may be the same as that of the user interface of the first program. That is, layout information about components constituting the user interface of the second program, setting values of the components, a display order of the components, display locations of the components, whether the components are displayed, etc., may be the same as layout information about components constituting the user interface of the first program, setting values of the components, a display order of the components, display positions of the components, whether the components are displayed, etc.

In addition, the definition information included in the first user interface definition file may be set to be commonly applicable to the plurality of programs. In addition, the definition information included in the first user interface definition file may be set to be commonly applicable to the first program and the second program. For example, in the first program and the second program, information on types into which the plurality of programs are classified based on preset criteria may be the same.

For example, in a case where the second program among the plurality of programs is executed on the electronic device 10, the processor 740 may call the first user interface definition file. The processor 740 may display the user interface of the second program through the user interface unit 720, based on the second definition information for the second program included in the first user interface definition file.

In this case, a layout of the user interface of the second program may be different from that of the user interface of the first program. For example, layout information about components constituting the user interface of the second program, setting values of the components, a display order of the components, display locations of the components, whether the components are displayed, etc., may be different from layout information about components constituting the user interface of the first program, setting values of the components, a display order of the components, display positions of the components, whether the components are displayed, etc.

In addition, the definition information included in the first user interface definition file may be set to be individually applicable to the plurality of programs. In addition, the definition information included in the first user interface definition file may be set to be commonly applicable to the first program and the second program. For example, in the first program and the second program, information on types into which the plurality of programs are classified based on preset criteria may be different.

For example, when a certain program among the plurality of programs is executed in the electronic device 10, the processor 740 may call the first user interface definition file pre-stored in the property bag, and obtain definition information for the certain program in the first user interface definition file. The processor 740 may, based on the definition information for the certain program, generate a user interface of the certain program and display a user interface generated through the user interface unit 720.

For example, after the user interface of the first program is provided, in a case where the first program is executed, the processor 740 may identify whether there is a second user interface definition file that is updated. For example, upon confirmation of the presence of an updated second user interface definition file, the processor 740 may update the user interface of the first program based on a second user interface definition file. Upon confirmation of the absence of an updated second user interface definition file, the processor 740 may display the user interface of the first program through the user interface unit 720, based on the first user interface definition file that is pre-stored.

For example, the processor 740 may obtain first target information for the first program in the first user interface definition file. The processor 740 may obtain, based on the first target information, the first definition information applied to the first program in the first user interface definition file. The processor 740 may generate a user interface of the first program based on the first definition information and display the generated user interface of the first program through the user interface unit 720.

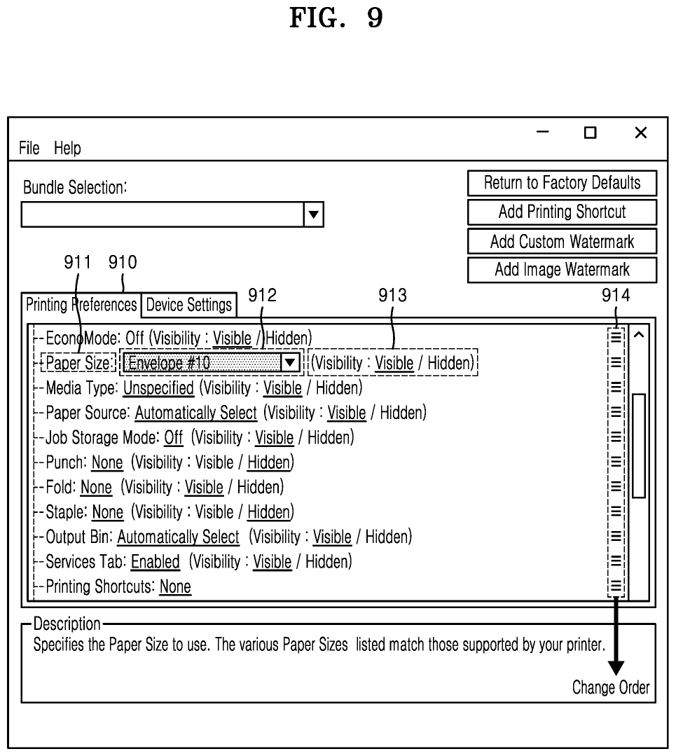

FIG. 8 is a flowchart illustrating a method of operating an administration device that generates a user interface definition file and distributes the user interface definition file, according to an example.

Referring to FIG. 8, in operation 810, the administration device 20 may receive layout information of the first user interface of the plurality of programs capable of controlling operations performed in an image-forming device.

For example, the administration device 20 may execute an administration program according to an administrator's input. Here, the administration program may be a program used to generate a user interface definition file corresponding to the plurality of programs. The administration device 20 may receive an input for setting layout information of the first user interface through a screen based on execution of the administration program.

For example, the layout information of the first user interface may include at least one piece of information among components constituting the first user interface, setting values of the components, display positions of the components, a display order of the components, whether to display the components, target information to which the first user interface is to be applied, etc.

In operation 820, the administration device 20 may generate a first user interface definition file referenced by the plurality of programs, based on the layout information of the first user interface.

For example, the first user interface definition file may be a file used to generate user interfaces of the plurality of programs that control operations performed in the image-forming device.

For example, the first user interface definition file may include definition information of a user interface commonly applicable to the plurality of programs or definition information of user interfaces individually applicable to the plurality of programs. In addition, the first user interface definition file may include definition information of applicable user interfaces for each of the types into which the plurality of programs are classified.

In operation 830, the administration device 20 may distribute the first user interface definition file to the electronic device 10. Here, the electronic device 10 may be a device that requests an operation performed by the image-forming device to the image-forming device. In the electronic device 10, a plurality of programs capable of controlling operations performed in the image-forming device may be installed.

For example, the administration device 20 may request that the user interface definition file be stored, by calling the API of the property bag in the electronic device 10 through the administration program.

FIG. 9 is a diagram illustrating a screen for receiving layout information of a user interface, according to an example.

Referring to FIG. 9, the administration device 20 may execute an administration program used to set information on a layout of the user interface of a program, according to an administrator's input. The administration device 20 may display a screen for receiving component information of components constituting the user interface of the program. Here, the program may be a program used to control operations of the image forming device in the electronic device 10. For example, the component may be a parameter used in an image forming operation in the image-forming device. The administration device 20 may receive an input for modifying the layout information of the user interface, based on the screen.

For example, an interface 910 for setting layout information of the user interface may be displayed on the screen. On the screen, information on a plurality of components, information on setting values of the plurality of components, information on whether to display the plurality of components, information on a display order of the plurality of components, display positions on the plurality of components, etc. may be displayed. As illustrated in FIG. 9, information on a first component 911 may be information indicating a paper size, information 912 on a setting value of the first component 911 may be information set to “Envelope #10”, and information 913 on whether to display the first component 911 may be information set to “Visible”.

Meanwhile, the information on the plurality of components displayed on the screen may be determined in advance based on functions supported by the image-forming device. In addition, initial setting values of the plurality of components may also be determined in advance.

For example, icons 914 capable of adjusting a display order of the plurality of components may be displayed on the screen. The administrator may select a first icon from among the icons 914 and adjust a position of the first icon.

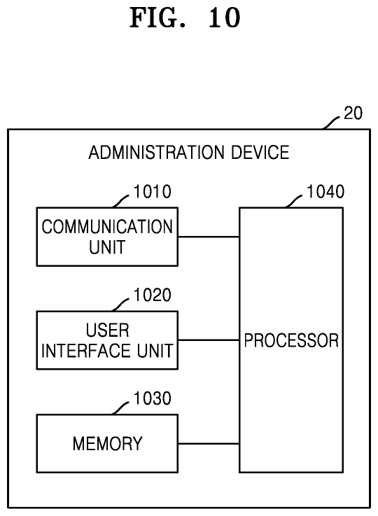

FIG. 10 is a block diagram illustrating an administration device, according to an example.

Referring to FIG. 10, the administration device 20 may include a communication unit 1010, a user interface unit 1020, a memory 1030, and a processor 1040. The administration device 20 may be implemented by more components than the illustrated components, and the administration device 20 may be implemented by fewer components. The components will be described below.

The communication unit 1010 (e.g., transceiver) may communicate with an external device. As an example, the communication unit 1010 may be connected to a network by wired or wireless communication to communicate with an external device. Here, the external device may be an image-forming device, the electronic device 10 that controls operations of the image forming device, or a server.

The user interface unit 1020 may include an input unit for receiving an input for controlling operations of the administration device 20 from the administrator, and an output unit for displaying information such as a result of the operations of the administration device 20, the status of the administration device 20, or the like. For example, the user interface unit 1020 may include an operation panel for receiving an administrator's input, a display panel for displaying a screen, and the like.

As an example, the input unit may include a device capable of receiving various types of administrator input, such as a keyboard, a physical button, a touch screen, a camera, a microphone, or the like. In addition, the output unit may include, for example, a display panel, a speaker, or the like.

The memory 1030 may store software, programs, etc. The memory 1030 may store at least one program related to an operation of the administration device 20 of generating a user interface definition file of a plurality of programs and distributing the generated user interface definition file to the electronic device 10 that controls operations of the image-forming device.

The processor 1040 may execute a program stored in the memory 1030, read data or files stored in the memory 1030, or store a new file in the memory 1030. The processor 1040 may execute instructions stored in the memory 1030.

The processor 1040 may receive, through the user interface unit 1020, layout information of a first user interface of a plurality of programs capable of controlling operations performed on the image-forming device.

For example, the processor 1040 may execute an administration program according to an administrator's input. Here, the administration program may be a program used to generate a user interface definition file corresponding to the plurality of programs. The user interface unit 1020 may receive, through a screen, an input for setting layout information of the first user interface according to execution of the administration program.

For example, the layout information of the first user interface may include at least one piece of information among components constituting the first user interface, setting values of the components, display positions of the components, a display order of the components, whether to display the components, target information to which the first user interface is to be applied, etc.

The processor 1040 may generate a first user interface definition file referenced by the plurality of programs, based on the layout information of the first user interface.

For example, the processor 1040 may, based on the layout information of the first user interface, generate a first user interface definition file that is used to generate user interfaces of a plurality of programs that control operations performed in the image-forming device.

For example, the processor 1040 may, based on the layout information of the first user interface, generate a first user interface definition file including definition information of a user interface commonly applicable to the plurality of programs or definition information of a user interface individually applicable to the plurality of programs. In addition, the processor 1040 may generate a first user interface definition file including definition information of a user interface applicable to types into which the plurality of programs are classified, based on the layout information of the first user interface.

The processor 1040 may distribute the first user interface definition file to the electronic device 10 through the communication unit 1010. Here, the electronic device 10 may be a device that requests an operation performed by the image-forming device to the image-forming device. In the electronic device 10, a plurality of programs capable of controlling operations performed in the image-forming device may be installed.

For example, the processor 1040 may request that the user interface definition file be stored, by calling the API of the property bag in the electronic device 10 through the administration program.

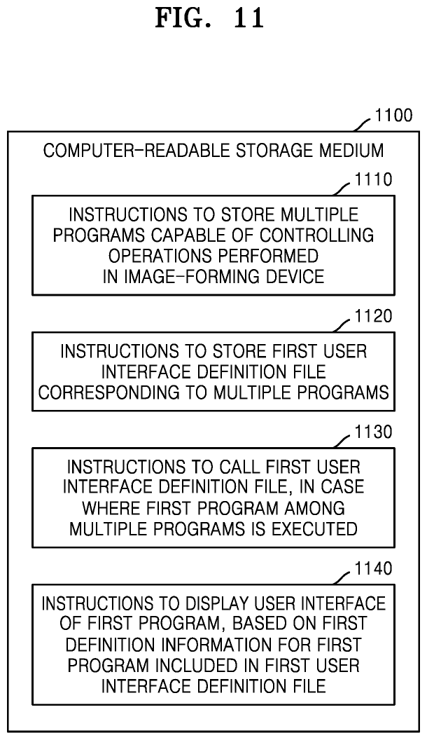

FIG. 11 is a diagram illustrating instructions stored in a computer-readable storage medium, according to an example.

Referring to FIG. 11, a computer-readable storage medium 1100 may store instructions related to example operations of the electronic device 10 described with reference to FIGS. 1 to 10. For example, the computer-readable storage medium 1100 may store instructions 1110 to store a plurality of programs capable of controlling operations performed in the image forming device, instructions 1120 to store a first user interface definition file corresponding to the plurality of programs, instructions 1130 to call the first user interface definition file in a case where a first program among the plurality of programs is executed, and instructions 1140 to display a user interface of the first program based on first definition information for the first program included in the first user interface definition file.

In addition, the computer-readable storage medium 1100 may store instructions to obtain a first user interface definition file corresponding to the plurality of programs, and instructions to store the obtained first user interface definition file in a designated location in a register.

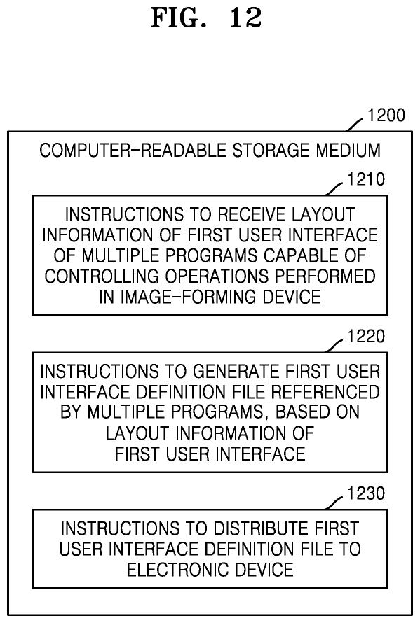

FIG. 12 is a diagram illustrating instructions stored in a computer-readable storage medium, according to an example.

Referring to FIG. 12, a computer-readable storage medium 1200 may store instructions related to example operations of the administration device 20 described with reference to FIGS. 1 to 10. For example, a computer-readable storage medium 1200 may store instructions 1210 to receive layout information of a first user interface of a plurality of programs capable of controlling operations performed in the image forming device, instructions 1220 to generate a first user interface definition file referenced by the plurality of programs, based on the layout information of the first user interface, and instructions 1230 to distribute the first user interface definition file to the electronic device 10.

Example methods of operating the electronic device 10 and the administration device 20 described above may be implemented in the form of a non-transitory computer-readable storage medium storing instructions or data executable by a computer or processor. The methods may be written using a program that may be executed in a computer, and may be implemented in a general-purpose digital computer that operates such a program by using a non-transitory computer-readable storage medium. The non-transitory computer-readable storage media may include read-only memory (ROM), random-access memory (RAM), flash memory, CD-ROMs, CD-Rs, CD+Rs, CD-RWs, CD+RWs, and DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, an optical data storage device, a hard disk, a solid-state disk (SSD), and store instructions or software, associated data, data files, and data structures, and may be any type of device capable of providing instructions or software, related data, data files, and data structures to a processor or computer so that the processor and the computer may execute the instructions.

As described above, although the examples have been described by a limited embodiment and drawings, those of skill in the art may make various modifications and variations from the above description. For example, even in a case where the described techniques are performed in a different order than the described method, and/or the components of the described system, structure, device, circuit, etc. are combined in a different form from the described method or are replaced or substituted by equivalents, appropriate results may be achieved.

It should be understood that examples described herein should be considered in a descriptive sense only and not for purposes of limitation. Descriptions of features or aspects within each example should typically be considered as available for other similar features or aspects in other examples. While examples have been described with reference to the figures, it will be understood by those of ordinary skill in the art that various changes in form and details may be made therein without departing from the spirit and scope as defined by the following claims.

What is claimed is:

1. An electronic device comprising:
a communication unit;
a user interface unit;
a processor; and
a memory to store instructions executable by the processor,
wherein the processor executes the instructions to:
store, in the memory, a plurality of programs capable of controlling operations performed in an image forming device,
store, in the memory, a first user interface definition file corresponding to the plurality of programs in the memory,
in a case where a first program among the plurality of programs is executed, call the first user interface definition file, and
based on first definition information for the first program included in the first user interface definition file, display a user interface of the first program through the user interface unit.

2. The electronic device of claim 1, wherein the first user interface definition file is applied to different programs of the plurality of programs based on different platforms or frameworks of different user interfaces, and includes layout information of a first user interface.

3. The electronic device of claim 2, wherein the layout information of the first user interface includes information of a component included in the first user interface, a setting value of the component, a display order of the component, a display position of the component, or whether the component is displayed.

4. The electronic device of claim 1, wherein the processor executes the instructions to store the first user interface definition file at a location designated by file location information stored in the memory.

5. The electronic device of claim 1, wherein the processor executes the instructions to:
in a case where a second program among the plurality of programs is executed, call the first user interface definition file, and
based on the first definition information for the first program included in the first user interface definition file, display a user interface of the second program through the user interface unit.

6. The electronic device of claim 1, wherein the processor executes the instructions to:
in a case where a second program among the plurality of programs is executed, call the first user interface definition file, and
based on second definition information for the second program included in the first user interface definition file, display a user interface of the second program through the user interface unit.

7. The electronic device of claim 1, wherein the processor executes the instructions to:
in a case where the first program is executed after the user interface of the first program is provided, confirm the presence of a second user interface definition file that is updated, and
in response to confirming the presence of the second user interface definition file that is updated, update the user interface of the first program based on the second user interface definition file.

8. The electronic device of claim 1, wherein the processor executes the instructions to:
obtain first target information for the first program from the first user interface definition file,
based on the first target information, obtain the first definition information applied to the first program in the first user interface definition file, and
based on the first definition information, generate a user interface of the first program and display the user interface of the first program through the user interface unit.

9. The electronic device of claim 1, wherein the processor executes the instructions to:
receive, through the communication unit, the first user interface definition file from an administration device that manages the image forming device, or
generate the first user interface definition file, based on an input for modifying layout information of a first user interface.

10. The electronic device of claim 1, wherein the first user interface definition file comprises an extensible markup language (XML) file.

11. An administration device comprising:
a communication unit;
a user interface unit;
a processor; and
a memory to store instructions executable by the processor,
wherein the processor executes the instructions to:
receive layout information of a first user interface of a plurality of programs capable of controlling an operation performed in an image forming device,
generate a first user interface definition file referenced by the plurality of programs, based on the layout information of the first user interface, and
distribute, through the communication unit, the first user interface definition file to an electronic device that requests the operation of the image forming device.

12. The administration device of claim 11, wherein the processor executes the instructions to receive, through the user interface unit, information of a component included in the first user interface, a setting value of the component, a display order of the component, a display position of the component, or whether the component is displayed.

13. The administration device of claim 11, wherein the first user interface definition file is applied to different programs of the plurality of based on different platforms or frameworks of different user interfaces, and includes the layout information of the first user interface.

14. The administration device of claim 1, wherein the processor executes the instructions to:
receive, through the user interface unit, an input for setting the plurality of programs to which the first user interface definition file is to be applied, and an input for setting layout information of a user interface for each of the plurality of programs, and
generate the first user interface definition file, in which definition information for a user interface is set for each of the plurality of programs.

15. A non-transitory computer-readable storage medium storing instructions executable by a processor, the non-transitory computer-readable storage medium comprising:
instructions to store a plurality of programs capable of controlling an operation performed in an image forming device;
instructions to store a first user interface definition file corresponding to the plurality of programs;
instructions to call the first user interface definition file in a case where a first program among the plurality of programs is executed; and
instructions to display the first user interface definition file, based on first definition information for the first program included in the first user interface definition file.
